(19) United States
(12) Patent Application Publication
(10) Pub. No.: US 2015/0199565 A1
(43) Pub. Date: Jul. 16, 2015

(54) FACILITATING HANDWRITING DEVELOPMENT

(71) Applicant: Jodi Brunsvold, Wellington, FL (US)

(72) Inventor: Jodi Brunsvold, Wellington, FL (US)

(21) Appl. No.: 14/152,997

(22) Filed: Jan. 10, 2014

(51) Int. Cl. G06K 9/00

(52) U.S. Cl. CPC G06K 9/00402

(57) ABSTRACT

Facilitating the development of handwriting can include a presentation medium and a user writing area. The user writing area can be presented by the presentation medium. The user writing area can include a plurality of zones. At least a portion of one or more of the zones can include an associated color. The color of at least one of the zones can be different from the color of the other zones. The colors of the zones can be selected and arranged according to a predetermined logical relationship.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments relate in general to handwriting and, more particularly, to facilitating the development of proper handwriting.

### BACKGROUND

Handwriting is a complex task that requires various skills. For instance, fine motor skills are required to hold and move a writing implement to form legible and correct letters. Spatial perception skills are also required to accurately place each letter, create each letter with suitable dimensions, and appropriately space each word. In addition, handwriting requires cognitive skills to learn letter formation to the point that it becomes automated.

A common way to assist someone in learning how to write is to use handwriting paper. Handwriting paper can be helpful in teaching letter placement, letter dimensions, word spacing and other aspects of handwriting. Handwriting paper typically presents a pair of solid lines with a dashed line in between each pair of solid lines. However, handwriting paper can be very confusing to some individuals learning to write, especially to young children who are still struggling with the basic spatial concepts associated with handwriting (e.g. top to bottom, left to right, tall and short letters, etc.).

### SUMMARY

One or more embodiments disclosed within this specification relate to facilitating the development of handwriting.

An embodiment can include a system for facilitating the development of handwriting. The system can include a presentation medium. In one or more arrangements, the presentation medium can be an electronic device or a portion thereof, such as a display of an electronic device. In one or more arrangements, the presentation medium can be a sheet of paper, a dry erase board, a chalkboard and/or a wall.

The system can include a user writing area. The user writing area can be presented by the presentation medium. The user writing area can include a plurality of zones. In one or more implementations, the plurality of zones can include three zones. In some arrangements, the plurality of zones can be substantially identical in size and/or shape to each other. In some arrangements, the plurality of zones can be stacked in a vertical direction.

At least a portion of one or more of the zones can have an associated color. The color of one or more of the zones can be different from the color of the other zones. The colors of the zones can be selected and arranged according to a predetermined logical relationship. As an example, the logical relationship can be a spatial relationship.

In some instances, the color associated with each zone can transition to a neutral color. The transition between the color and the neutral color can occur in any suitable manner. For instance, the transition between the color and the neutral color can occur gradually.

In some instances, a boundary indicator can be provided between at least one pair of neighboring zones. In some instances, a boundary indicator can be provided along at least an outer portion of a zone that is not bordered by another zone.

In some arrangements, the presentation medium can present one or more sample characters. The presentation medium can also present one or more direction indicators with the one or more sample characters. The presentation medium can present instructions for forming a character. The presentation medium can present a legend indicating a thing corresponding to the color associated with each zone.

In other respects, arrangements are directed to a system for facilitating the development of handwriting. The system includes a presentation medium. In one implementation, the presentation medium can be a display of an electronic device. The system also includes a writing area. The writing area is presented by the presentation medium.

The writing area includes three vertically stacked zones. The three zones are substantially identical in size and shape. At least a portion of each of the zones is filled with an associated color. The color associated with each zone is different from the color of the other zones. The colors of the zones are selected and arranged according to a spatial relationship.

The three zones can include an upper zone, a middle zone and a lower zone. In one or more arrangements, the color associated with the upper zone can be blue, the color associated with the middle zone can be green, and the color associated with the lower zone can be brown.

In some arrangements, a boundary indicator can be provided between one or more pairs of neighboring zones. In other arrangements, a boundary indicator can be provided along at least an outer portion of a zone that is not bordered by another zone.

### BRIEF DESCRIPTION OF THE DRAWINGS

FIG. 1 is an example of a handwriting development system, showing a plurality of user writing areas, each writing area including a plurality of zones with colors that are selected and arranged according to a predetermined logical relationship.

FIG. 2 is an example of a handwriting development system, showing a plurality of user writing areas including boundary indicators.

FIG. 3 is an example of a handwriting development system, showing a plurality of user writing areas with sample characters, direction indicators and instructions.

FIG. 4 is an example of a handwriting development system, showing a plurality of user writing areas with sample characters, direction indicators and instructions.

FIG. 5 is an example of a handwriting development system, showing a plurality of user writing areas in which a color region in each zone transitions to a neutral color region.

FIG. 6 is an example of a handwriting development system, showing a plurality of user writing areas that alternate between user writing areas with color zones and user writing areas with neutral color zones.

FIG. 7 is an example of a handwriting development system, showing an orientation indicator.

FIG. 8 is an example of a handwriting development system, showing a plurality of user writing areas arranged in a landscape orientation.

FIG. 9 is an example of a handwriting development system, showing a legend for the color zones of a user writing area.

FIG. 10 is an example of a handwriting development system, showing an example of letters that are substantially formed in a middle zone of a user writing area.

FIG. 11 is an example of a handwriting development system, showing an example of letters that are substantially formed in a middle zone of a user writing area and extend into an upper zone.

FIG. 12 is an example of a handwriting development system, showing an example of letters that are substantially formed in a middle zone of a user writing area and extend into a lower zone.

FIG. 13 is a block diagram illustrating an example of a system configured to facilitate handwriting development.

FIG. 14 is a block diagram illustrating an example of a system configured to facilitate handwriting development.

### DETAILED DESCRIPTION

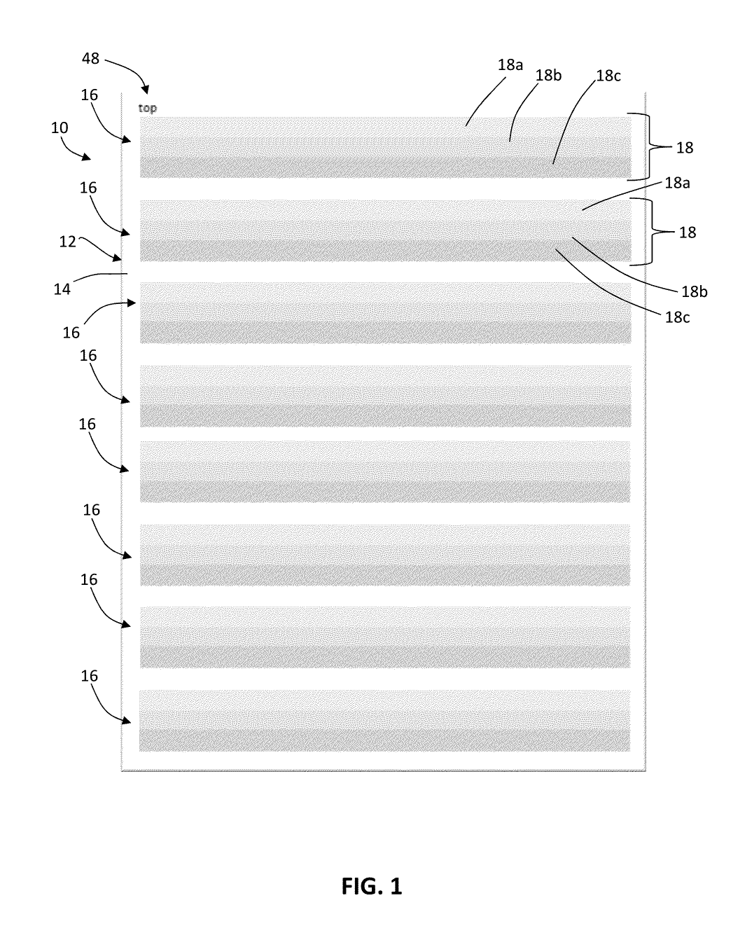

Arrangements described herein relate to handwriting development and associated apparatus, systems and methods. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 1-14, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of a handwriting development system 10 is shown. The handwriting development system 10 can include a presentation medium 12. A “presentation medium” is one or more devices, components, systems, apparatus, surfaces, bases, substrates, materials and/or combinations thereof that present one or more handwriting facilitating elements. Various examples of handwriting facilitating elements (e.g. a user writing area 16) are described herein. The handwriting facilitating elements can be presented by the presentation medium 12 in any suitable manner. In some instances, the handwriting facilitating elements and/or user writing areas can be presented in, on, under and/or in any other suitable manner by the presentation medium 12.

Various examples of the presentation medium 12 will now be described. However, it will be understood that these examples are provided merely to facilitate the description and that embodiments are not limited to the described examples. In one implementation, the presentation medium 12 can be a sheet of paper 14. The paper 14 can be any suitable size. It can be a standard size (e.g. letter, legal, etc.) or any non-standard size. In some instances, the presentation medium 12 can be a plurality of sheets of paper grouped together in any manner, such as in the form of a book. Additional examples of the presentation medium 12 can include a dry erase board, a chalkboard or a wall.

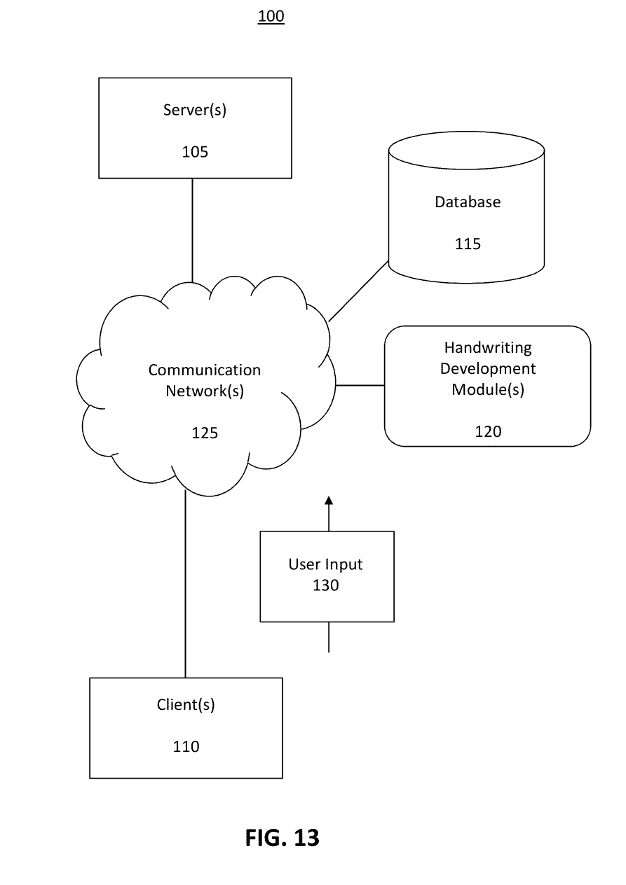

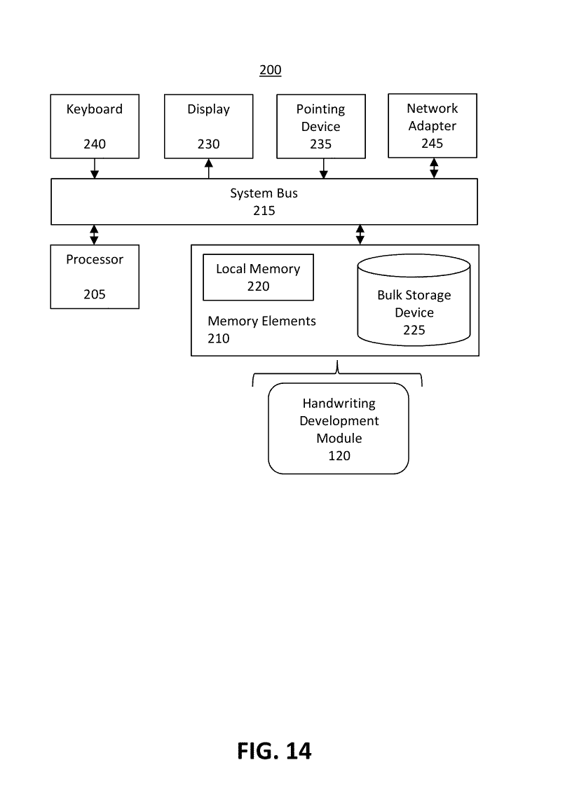

In some instances, the presentation medium 12 can be an electronic device. More particularly, the presentation medium 12 can be the display of an electronic device. The electronic device can be any suitable device, including any of the client devices described below in connection with FIG. 13. Likewise, the display can be any suitable display, including any of the examples of a display 230 described below in connection with FIG. 14.

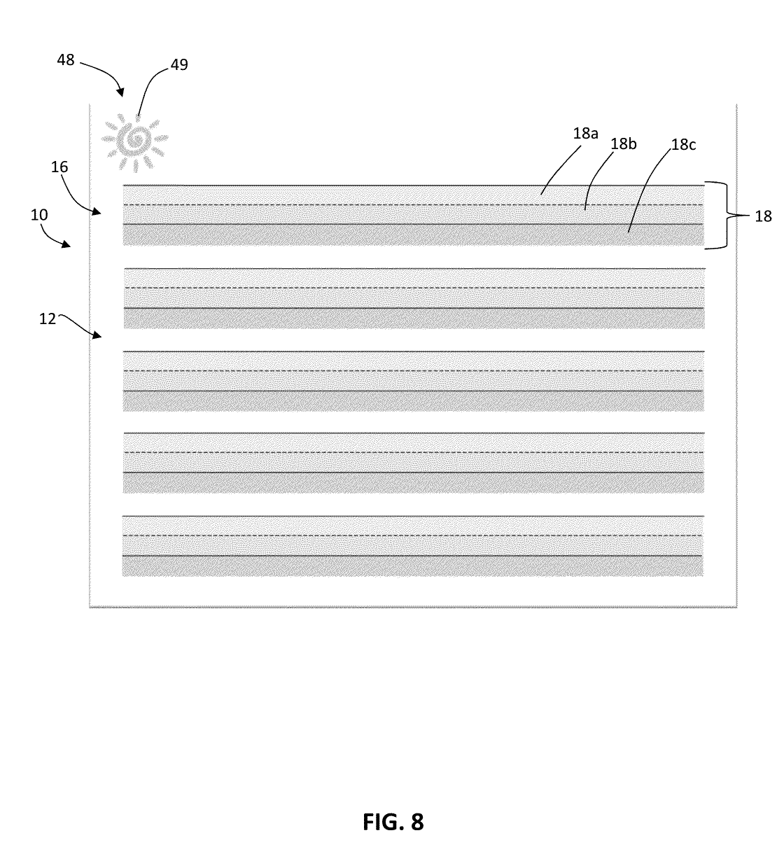

The presentation medium 12 can present one or more user writing areas 16. A “user writing area” is any space, area, field and/or region configured to receive a user's handwriting input. The input from a user (e.g. a person) can be provided in any suitable manner, such as by writing, drawing, tracing, gesturing and/or other suitable manner of input. The one or more user writing areas 16 can be arranged on the presentation medium 12 in any suitable manner. For instance, if the presentation medium 12 is a sheet of paper, the one or more writing areas 16 can be arranged in a portrait orientation (see FIGS. 1-7) and/or a landscape orientation (see FIG. 8). However, it will be understood that other orientations and combinations thereof are possible.

Each user writing area 16 can include a plurality of zones 18. A “zone” is any subset of the user writing area. The plurality of zones 18 can be substantially identical to each other in size and/or shape. In some instances, one or more of the zones 18 can have a different size and/or shape from the other zones 18. The plurality of zones 18 can have substantially the same width and/or length, or at least one of the plurality of zones 18 can have a different width and/or length than the other zones 18.

The zones 18 can be arranged in any suitable manner. For instance, the plurality of zones 18 can extend substantially parallel to each other across at least a portion of the presentation medium 12. The plurality of zones 18 can be substantially adjacent to each other. That is, each of the zones 18 can be substantially adjacent to one or more other zones 18. “Substantially adjacent” includes directly touching (e.g. no spacing between them) or a slight spacing therebetween.

In one or more implementations, each user writing area 16 can include three zones—an upper zone 18a, a middle zone 18b and a lower zone 18c. The upper zone 18a can be substantially adjacent to the middle zone 18b, and the lower zone 18c can be substantially adjacent to the middle zone 18b on an opposite side thereof from the upper zone 18a. It will be understood that an arrangement with three zones 18 is provided merely as an example. In some implementations, there can be more than three zones 18 or fewer than three zones 18.

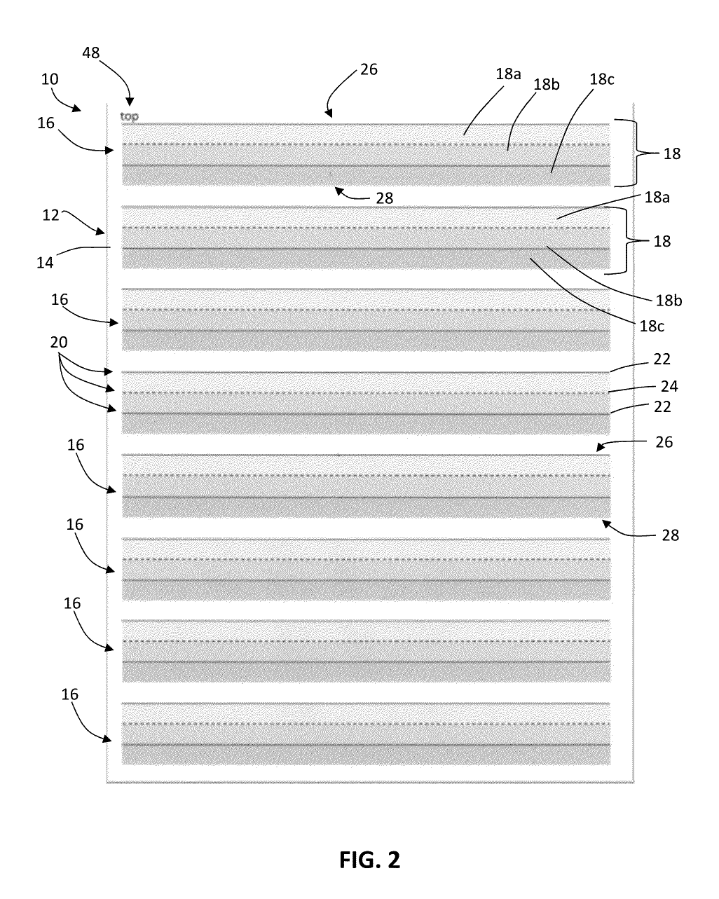

Each of the zones 18 can have associated boundaries. In at least some implementations, one or more of the boundaries of one or more zones can be marked by a boundary indicator 20, as is shown in FIG. 2. Any suitable boundary indicator 20 can be used. In one or more arrangements, the boundary indicator 20 can be a line. The line can be a solid line 22. Alternatively, the line can be a non-solid line, such as a dashed line 24, a dotted line, an intermittent line, a broken line, a long dash line, a short dash line, or a double line. The boundary indicator 20 can be any combination of one or more lines or other boundary indicators. Further, the boundary indicator 20 can be any combination of one or more line types or boundary indicator types.

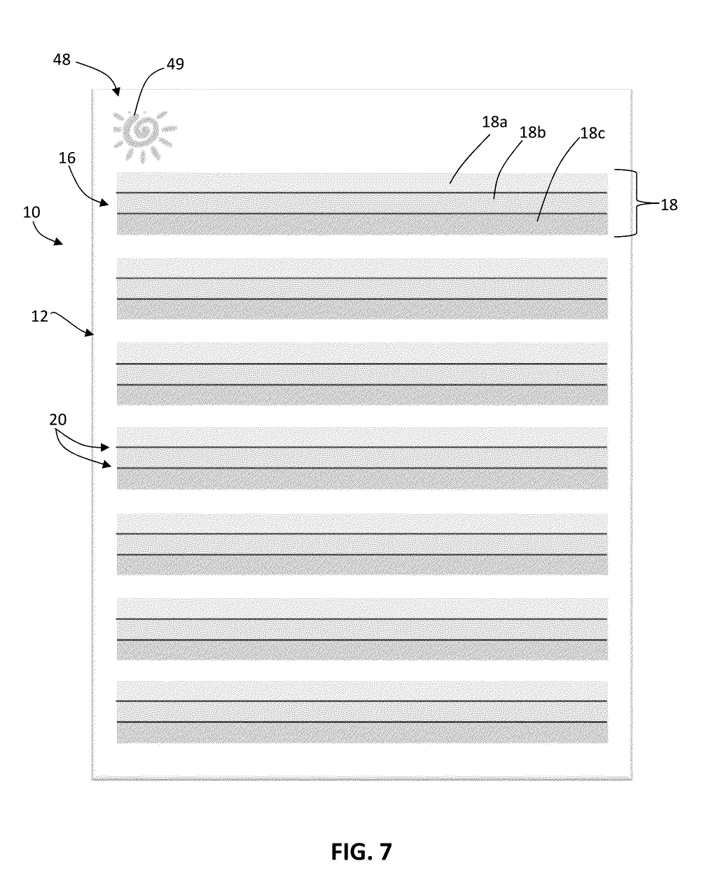

In at least some implementations, two neighboring zones 18 can be separated from each other by one or more boundary indicators 20. As an example, the upper zone 18a and the middle zone 18b can be separated by a dashed line 24, as is shown in FIG. 2. Alternatively or in addition, the middle zone 18b and the lower zone 18c can be separated by a solid line 22, as is shown in FIG. 2. FIG. 7 shows an example in which the upper zone 18a and the middle zone 18b can be separated by a solid line 22, and in which the middle zone 18b and the lower zone 18c can be separated by a solid line 22.

In at least some implementations, one or more portions of a zone 18 that is not substantially adjacent to another zone 18 can be marked by one or more boundary indicators 20 to show the boundary of the zone 18. For instance, an upper boundary 26 of the upper zone 18a can be marked by a solid line 22, as is shown in FIG. 2, or other suitable boundary indicator. Similarly, in at least some instances, there can be a line or other suitable boundary indicator 20 to mark a lower boundary 28 of the lower zone 18c. However, in some instances, one or more of the zone boundaries (e.g. the upper boundary 26 of the upper zone 18a and/or the lower boundary 28 of the lower zone 18c) may not be marked. As an example, FIG. 2 shows an arrangement in which the upper boundary 26 of the upper zone 18a can be marked by a solid line 22, and the lower boundary 28 of the lower zone 18c may not be marked by a line.

At least a portion of each of the zones 18 can have an associated color. In some instances, the color associated with at least a portion of one of the zones 18 can be different from the color associated with at least a portion of the other zones 18. In some instances, each zone 18 can have a different color. In other instances, the plurality of zones 18 can have associated colors that are variants of the same color. As an example, a first zone can be a light blue (e.g. sky blue), a second zone can be blue and a third zone can be a dark blue (e.g. midnight blue). Alternatively, two or more of the colors can be the same color, but with one or more different characteristics (e.g. hues, shades, tint, colorfulness, chroma, saturation and/or value). In some instances, two of the zones 18 can be substantially the same color. In such an instance, the zones 18 can be spaced, that is, non-adjacent to each other.

In some instances, one or more of the zones 18 can be a neutral color. A “neutral color” means a color that is clear, transparent or substantially identical to the color of the presentation medium 12. “Substantially identical” includes identical and slight variations therefrom. In one embodiment, if the presentation medium 12 is a white sheet of paper or a white dry erase board, the neutral color can be white. If the presentation medium 12 is a black chalkboard, the neutral color can be black.

According to embodiments herein, the colors associated with the zones 18 can be selected and arranged according to a predetermined logical relationship. As an example, the colors associated with the zones 18 can be selected and arranged according to a spatial relationship. “Selected and arranged according to a spatial relationship” means that the colors are selected to correspond to natural and/or non-natural things commonly found in reality and that the colors are arranged to correspond to a typical arrangement of these natural and/or non-natural things commonly found in reality. If the zones 18 of the user writing area 16 are provided in a vertically stacked arrangement when in the intended orientation, as is shown in FIGS. 1-2, the spatial relationship can be related to any vertical arrangement of natural and/or non-natural things commonly found in reality. The correspondence between the selected colors and the natural and/or non-natural things commonly found in reality can vary depending on the age and/or ability of the user. For instance, the correspondence may be relatively straightforward for younger users, whereas the correspondence may be more complex or abstract for older, more mature and/or more intelligent users.

An example of a combination of zone colors that is selected and arranged according to a spatial relationship is blue, green and brown. More particularly, at least a portion of the upper zone 18a can be blue, at least a portion of the middle zone 18b can be green, and at least a portion of the lower zone 18c can be brown. The blue can correspond to the sky, the green can correspond to grass or plants, and the brown can correspond to the dirt or soil.

While the above discussion is directed to zone colors selected and arranged according to a spatial relationship, it will be appreciated that embodiments are not limited to this type of a logical relationship. Indeed, other types of logical relationships are possible. Examples of other types of logical relationships that the zone colors can be selected and arranged according to can include temporal relationships and/or temperature relationships.

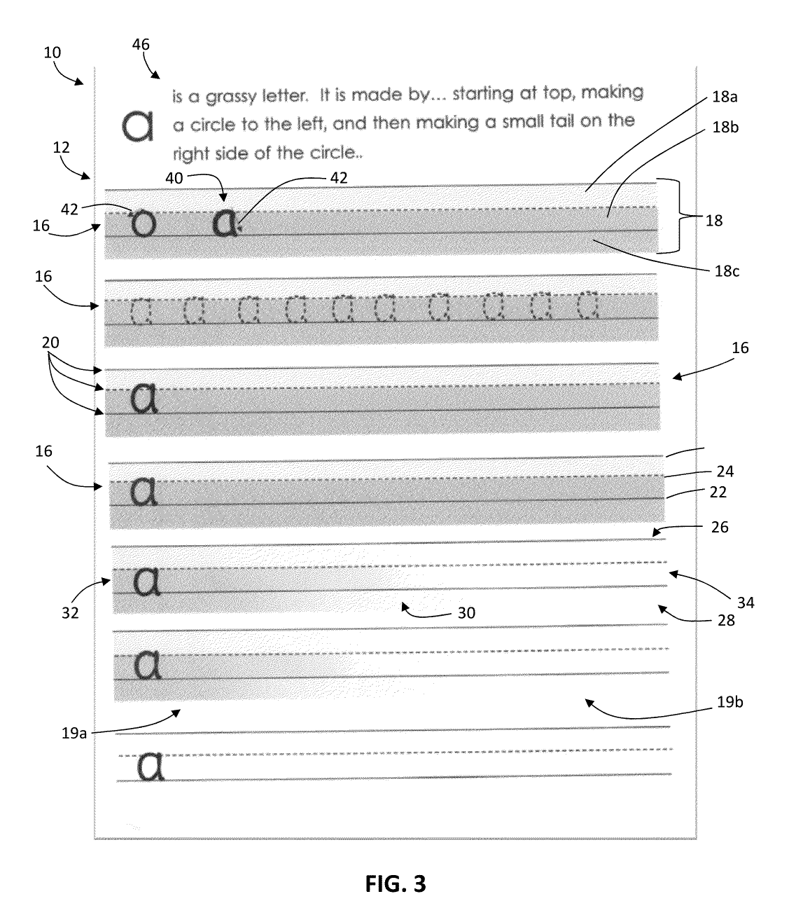

In some instances, the color associated with a zone 18 can extend across or otherwise fill the entire zone 18, as is shown in FIGS. 1-2. Alternatively, the color associated with a zone 18 can be provided in one or more portions of a zone 18. In such case, there can be at least one color region 19a that transitions to a neutral color region 19b. Examples of such an arrangement are shown in FIGS. 3-5. The neutral region can include any region that is a neutral color.

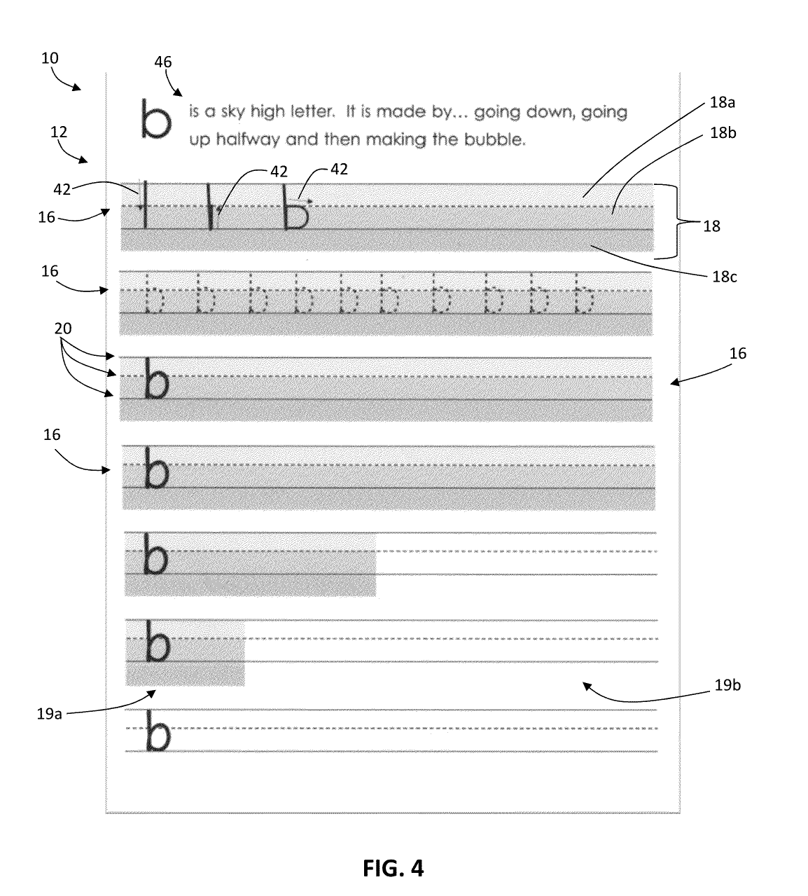

The transition between the color region 19a and a neutral region 19b can occur in any suitable manner. For instance, there can be an immediate change between the color region and the neutral region. Examples of such an arrangement are shown in FIG. 4. Such an immediate transition can occur at any suitable point along the length of the zone 18. For example, the transition can occur in a middle region 30 of the zone 18. Alternatively, the transition can occur at a point that is about 5%, about 10%, about 15%, about 20%, about 25%, about 30%, about 35%, about 40%, about 45%, about 50%, about 55%, about 60%, about 65%, about 70%, about 75%, about 80%, about 85%, about 90% or about 95% across the zone. These various examples of locations of the transition can be measured relative to a left lateral end 32 of the zone 18, or they can be measured relative to a right lateral end 34 of the zone 18.

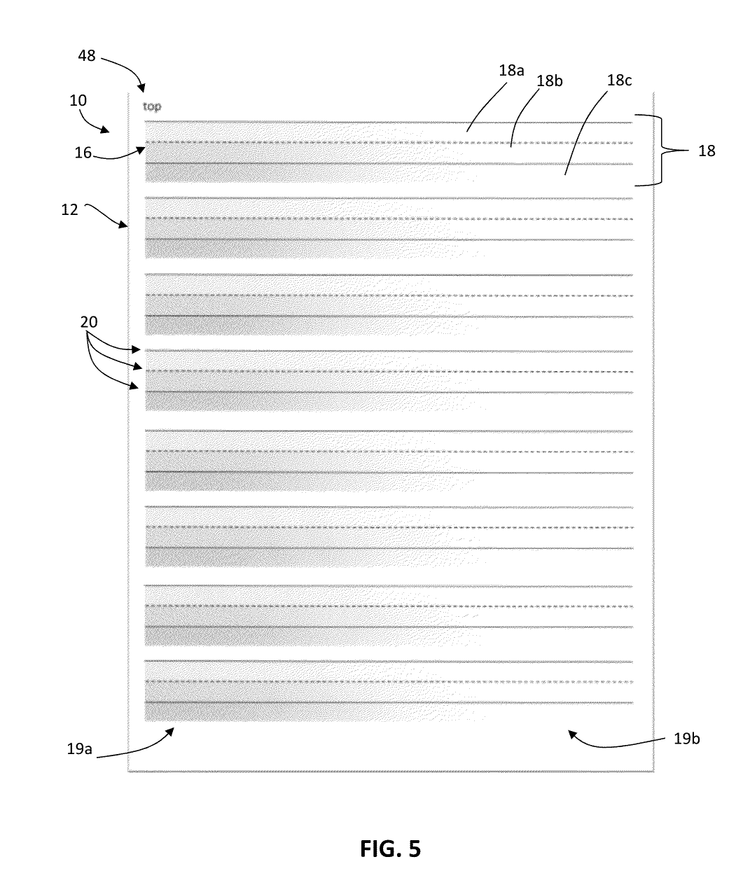

Alternatively, the transition between the color region and a neutral region can occur gradually across at least a portion of the zone 18. For instance, the transition can be a gradual fading of the color associated with the zone 18 to the neutral color. An example of such an arrangement is shown in FIGS. 3 and 5.

In some instances, the transition can occur horizontally across a zone 18. In such case, there can be a color region beginning on the left hand side of the zone 18 and a neutral region on the right hand side of the zone 18 with any suitable transition between them. Alternatively, for one or more of the zones 18, there can be a color region beginning on the right hand side of the zone 18 and a neutral region on the left hand side of the zone with any suitable transition between them.

In some instances, there can be a color region in a central portion of one or more of the zones. There can be a neutral region on the right hand side and/or the left hand side of the color region. Alternatively, there can be a neutral region in a central portion of one or more of the zones. There can be a color region of the right hand side and/or left hand side of the neutral region.

In some implementations, a single user writing area 16 may be presented. In other implementations, a plurality of user writing areas 16 can be presented. In such case, the plurality of user writing areas 16 can be arranged, distributed and/or presented in any suitable manner. For instance, the user writing areas 16 can arranged in rows. The user writing areas 16 can be substantially parallel to each other. The user writing areas 16 can be spaced from each other. One or more of the user writing areas 16 can be non-parallel to the other user writing areas 16.

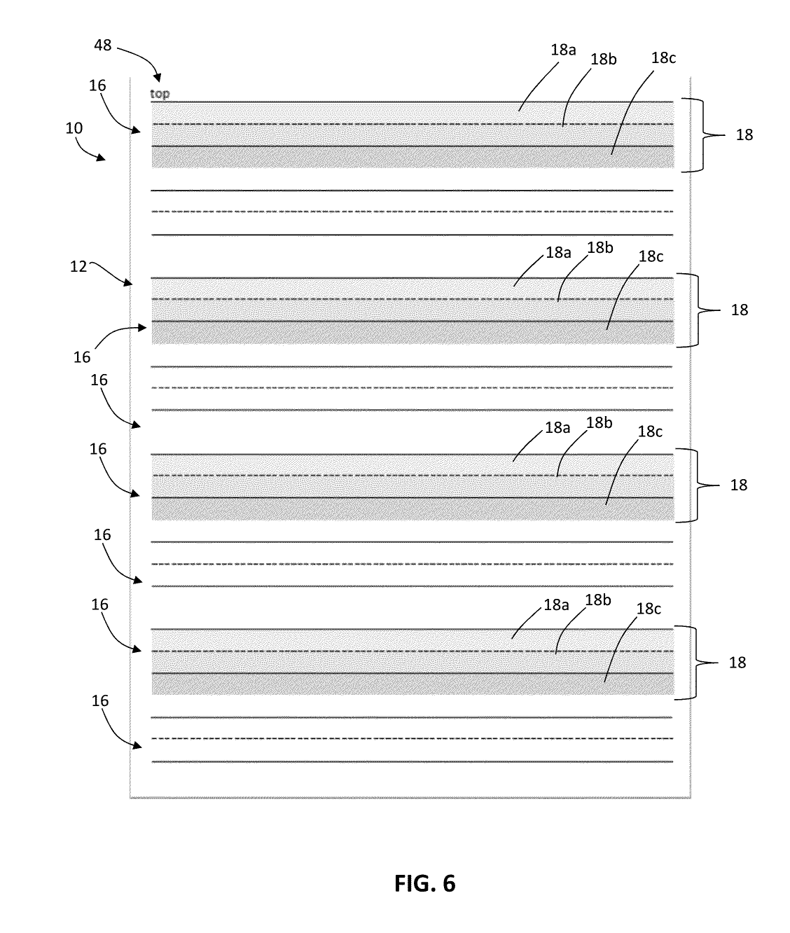

In implementations in which a plurality of user writing areas 16 are presented, the plurality of user writing areas 16 can be substantially identical to each other. Alternatively, one or more of the user writing areas 16 can be different from the other writing areas in one or more respects, including in one or more of the various ways described above. As an example, FIGS. 3-4 show arrangements in which a first subset of the plurality of writing areas 16 includes zones 18 that are entirely filled with color. A second subset of the plurality of writing areas 16 includes zones 18 that are partially filled with color. A third subset of the plurality of writing areas 16 includes one or more zones 18 that are blank, that is, they do not have an associated color. As a further example, FIG. 6 shows an arrangement in which user writing areas 16 that include zones 18 that have color alternating with user writing areas 16 that have zones that are blank, non-colored and/or neutral colored.

It should be noted that one or more sample characters 40 can be presented by the presentation medium 12. The one or more sample characters 40 can be letters, words, phrases, sentences, punctuation, symbols, numbers and/or other characters. The one or more sample characters 40 can be presented to show a user the proper look of the character and/or the proper formation of the character with respect to the zones 18. Alternatively or in addition, the sample characters 40 can be used for tracing to allow a user to get a sense of the proper way to form the character. For instance, one or more sample characters 40 can be presented within one or more of the user writing areas 16. An example of such an arrangement is shown in FIGS. 3 and 4. Alternatively or in addition, one or more sample characters 40 can be located outside of the user writing areas 16.

The sample characters 40 can be provided in any suitable form. For instance, the sample characters 40 can be formed using solid lines or markings. Alternatively or in addition, the sample characters 40 can be formed using non-solid lines or markings. Such non-solid lines or markings may facilitate tracing.

Further, there can be one or more direction indicators 42 can be associated with at least a portion of one or more of the sample characters 40. An example of direction indicators 42 is shown in FIGS. 3-4. The one or more direction indicators 42 can show a direction of movement to guide a user in forming the sample character.

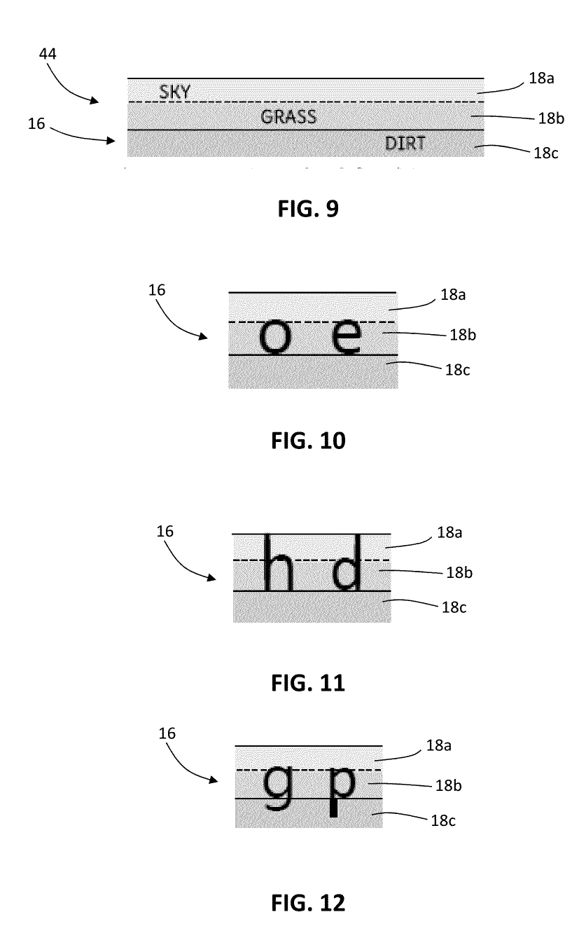

In addition, the handwriting development system 10 can include a legend 44. An example of a legend 44 is shown in FIG. 9. The legend 44 can be presented by the presentation medium 12 in any suitable manner. In one implementation, the legend 44 can show at least a portion of a user writing area 16. Words can appear in each zone to convey to the user the meaning of the colors associated with each zone 18. For instance, the word sky can appear in a zone that is blue, the word grass can appear in a zone that is green, and the word direct can appear in a zone that is brown.

The handwriting development system 10 can include instructions 46. The instructions 46 can be presented to the user of the handwriting development system 10 in any suitable manner. For instance, the instructions 46 can be written instructions. In such case, the presentation medium 12 can present and/or display the instructions 46. Alternatively or in addition, the instructions 46 can be conveyed audibly by an individual, device or entity. For instance, an instructor can read instructions 46 aloud to the user. Alternatively, an electronic device can include an output system in which the instructions 46 are presented to a user by audio output.

Regardless of the particular manner in which the instructions 46 are conveyed, the instructions 46 can include a reference to the colors associated with the plurality of zones 18 of the user writing area 16. An example will now be provided in which at least a portion of the upper zone 18a is blue, at least a portion of the middle zone 18b is green and at least a portion of the lower zone 18c is brown. In such case, letters or other characters that are substantially only in the middle zone 18b can be referred to as grassy letters or characters. Examples of grassy letters are shown in FIG. 10. Letters or other characters that are in the middle zone and extend into the upper zone 18a can be referred to as sky high letters or characters. Examples of sky high letters are shown in FIG. 11. Letters or other characters that are in the middle zone and extend into the lower zone 18c can be referred to as dirty letters. Examples of dirty letters are shown in FIG. 12. Other aspects of the user writing areas 16 can be referenced in the instructions 46. For instance, the non-solid line 24 separating the upper zone 18a and the middle zone 18b can be referred to as a fence or other thing that may be related to one or more of the things that the zone colors represent.

FIG. 3 shows an example of instructions for forming a lowercase letter a. This letter can be formed entirely within the middle zone. Thus, the instructions can include a reference to the color associated with the middle zone. As an example, the instructions can refer to the lowercase letter a as being a grassy letter. Additional instructions can be provided for one or more ways of forming the letter.

FIG. 4 shows an example of instructions for forming a lowercase letter b. The lowercase letter b can be formed in the middle and upper zones. Thus, the instructions can include a reference to the color of the upper zone and/or the middle zone. For instance, the instructions can refer to the lowercase letter b as being a sky high letter. Additional instructions can be provided for one or more ways of forming the letter.

Again, FIGS. 3 and 4 are provided as non-limiting examples. It will be understood that the instructions can vary depending on the letter or character being presented.

It should be noted that one or more page orientation indicators 48 can be presented by the presentation medium 12. The one or more page orientation indicators 48 can indicate to a user the proper orientation of the presentation medium 12. The one or more page orientation indicators 48 can be letters, words, phrases, sentences, punctuation, symbols, numbers and/or other characters. As an example, FIGS. 1-2 and 5-6 show arrangements in which the page orientation indicator 48 that is a word. In these examples, the word “TOP” can be used to indicate that it is the top of the presentation medium 12 or page. Thus, the page orientation indicator 48 can be located in an upper region of the presentation medium 12 when oriented as intended. An example in which the page orientation indicator 48 is a symbol is shown in FIGS. 7-8.

In some instances, the page orientation indicator 48 can be related to the predetermined logical relationship for the selection and arrangement of the colors of the zones 18. An example of such an arrangement is shown in FIGS. 7-8. In this implementation, the page orientation indicator 48 can be a graphical representation of a sun 49. As is shown in FIGS. 7-8, the position of the graphical representation of a sun 49 can be located in an upper region of the presentation medium 12 when oriented in the intended direction. With respect to the user writing areas 16, the graphical representation of a sun 49 can be arranged above the upper zone (.e.g. blue for the sky) and, thus, is consistent with the predetermined logical relationship for the selection and arrangement of the colors of the zones 18. Alternatively or in addition, the page orientation indicator 48 can be a graphical representation of a worm (not shown), which can be located in a lower region of the presentation medium 12 when oriented in the intended direction. With respect to the user writing areas 16, the graphical representation of a worm can be arranged below the lower zones 18c (e.g. brown for dirt) and, thus, is consistent with the predetermined logical relationship for the selection and arrangement of the colors of the zones 18.

A user can use a writing implement to attempt to write, draw, trace, gesture, form or otherwise input one or more letters or characters within the user writing area 16 presented by the presentation medium 12. Any suitable type of writing implement can be used. For instance, the writing implement can be a pen, pencil, crayon, marker, chalk, dry erase marker, just to name a few possibilities. Further, the writing implement can be a finger, a stylus, a mouse, a joystick, a trackball. In some implementations, the handwriting development system 10 can be adapted to detect movement of a portion of a user's body, such as eye movement, and to translate such movement into an input in the user writing area.

FIG. 13 is a block diagram illustrating a system 100 for facilitating the development of handwriting in accordance with one or more embodiments herein. The system 100 can include one or more servers 105, one or more clients 110, and one or more databases 115. The system 100 further can include a handwriting development module 120. The various components of system 100 can be communicatively linked through one or more communication networks 125. As used herein, the term “communicatively linked” can include direct or indirect connections through a communication channel or pathway or another component or system. A “communication network” means one or more components designed to transmit and/or receive information from one source to another.

The one or more communication networks 125 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network 125 further can be implemented as or include one or more wireless networks, whether short or long range. For example, in terms of short range wireless networks, the communication network 125 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communication network 125 can include a mobile, cellular, and or satellite-based wireless network and support voice, video, text, and/or any combination thereof. Examples of long range wireless networks can include GSM, TDMA, CDMA, WCDMA networks or the like. The communication network 125 can include wired communication links and/or wireless communication links. The communication network 125 can include any combination of the above networks and/or other types of networks. The network can include one or more routers, switches, access points, wireless access points, and/or the like.

The one or more servers 105 can include suitable operational software for performing the various functions described herein. The client(s) 110 can be implemented as any of a variety of communication devices executing suitable communication software. For example, each client can be implemented as a computer system or other information processing system. The client(s) 110 can be any suitable device including, for example, a cellular telephone, a smart phone, a personal digital assistant (“PDA”), a digital reader, a computer (e.g., a laptop, tablet, desktop, etc.), a portable electrical device, a portable computing device, an entertainment device (e.g., a music or video device), an e-book reader or a game console. In some instances, the client(s) 110 can be configured to communicate via a wireless or a wired medium. Embodiments described herein can be implemented into any suitable electronic device, including any of those listed above. Each client 110 can include and/or execute suitable communication software, which enables the client 110 to communicate with the server 105 and/or other clients through the communication network 125 and/or otherwise, and to perform the functions disclosed herein.

The system 100 can include a handwriting development module 120. In one embodiment, the handwriting development module 120 can be stored on, accessed by and/or executed on the one or more clients 110. Alternatively or in addition, the handwriting development module 120 can be stored on, accessed by and/or executed on the one or more servers 105.

The handwriting development module 120 can be implemented as computer readable program code that, when executed by a processor, implement the various processes described herein. The handwriting development module 120 and/or the database 115 can include one or more handwriting development arrangements depending on the letter(s), word(s), phrase(s), sentence(s), punctuation, symbol(s), number(s) and/or other character(s) at hand.

The handwriting development module 120 can collect data input by the user. The data can be collected in any suitable manner by the handwriting development module 120. The collected data can be stored in the database 115.

FIG. 14 is a block diagram illustrating an example of a data processing system 200. System 200 can include at least one processor (e.g., a central processing unit) 205 coupled to memory elements 210 through a system bus 215 or other suitable circuitry. As such, system 200 can store program code within memory elements 210. Processor 205 executes the program code accessed from memory elements 210 via system bus 215 or the other suitable circuitry.

In one aspect, system 200 is implemented as a computer or other programmable data processing apparatus that is suitable for storing and/or executing program code. It should be appreciated, however, that system 200 can be implemented in the form of any system including a processor and memory that is capable of performing and/or initiating the functions and/or operations described within this specification. Further, system 200 can be implemented in any of a variety of different form factors including, but not limited to, a portable device such as a mobile communication device, a tablet computing and/or communication device, a laptop computing device, a desktop computing device, a server, or the like.

Memory elements 210 include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard disk drive (HDD), solid state drive (SSD), or other persistent data storage device. System 200 also can include one or more cache memories (not shown) that provide temporary storage of at least some program code in order to reduce the number of times program code must be retrieved from bulk storage device 225 during execution.

Input/output (I/O) devices such as a keyboard 240, a display 230, and a pointing device 235 optionally can be coupled to system 200. The I/O devices can be coupled to system 200 either directly or through intervening I/O controllers. One or more network adapters 245 also can be coupled to system 200 to enable system 200 to become coupled to other systems, computer systems, remote printers, and/or remote storage devices through intervening private or public networks. Modems, cable modems, wireless transceivers, and Ethernet cards are examples of different types of network adapters 245 that can be used with system 200.

The display 230 can be any suitable type of display, including, for example, a liquid crystal display (LCD), a light emitting diode (LED) based display or other type of display. In one embodiment, the display 230 can be a touch screen display or a multi-touch display. The touch screen can allow a user to engage or interact with one or more displayed elements, such as a graphical user interface (GUI), and/or other applications running on a device through, for example, contact with the display 230. For example, a user may draw letters or characters or make selections and move a cursor by simply touching the display via a finger or stylus, which may be interpreted by the device to perform an action based on the touch event.

As pictured in FIG. 14, memory elements 210 can store a handwriting development module 120. Handwriting development module 120, being implemented in the form of executable program code, is executed by system 200 and, as such, is considered an integrated part of system 200. In at least some instances, handwriting development module 120 can assess the correctness of a user input 130 relative to the letter, word, phrase, sentence, punctuation, symbol, number and/or other character at issue. Moreover, the handwriting development module 120, including any parameters and/or attributes utilized by module 120, are functional data structures that impart functionality when employed as part of system 200.

Master versions of the handwriting development system for each letter, word, phrase, sentence, punctuation, symbol, number and/or other character can be output to, and stored within, memory elements 210. As used herein, “outputting” and/or “output” can mean storing in memory elements 210, for example, writing to a file stored in memory elements 210, writing to display 230 or other peripheral output device, playing audible notifications, sending or transmitting to another system, exporting, or the like.

It will be appreciated that the systems and methods described above can provide numerous benefits. For instance, embodiments described herein can assist users in the development of their handwriting. Embodiments can help users learn how to formulate letters. Embodiments can help users learn the correct sizing of the letters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A system for facilitating the development of handwriting comprising:
a presentation medium;
a user writing area presented by the presentation medium, the user writing area including a plurality of zones, at least a portion of one or more of the zones including an associated color, the color of at least one of the zones being different from the color of the other zones, the colors of the zones being selected and arranged according to a predetermined logical relationship.

2. The system of claim 1, wherein the logical relationship is a spatial relationship.

3. The system of claim 1, wherein the plurality of zones includes three zones.

4. The system of claim 1, wherein the color associated with each zone transitions to a neutral color.

5. The system of claim 4, wherein the transition between the color and the neutral color occurs gradually.

6. The system of claim 1, wherein the presentation medium is a display of an electronic device.

7. The system of claim 1, wherein the presentation medium is one of a sheet of paper, a dry erase board, a chalkboard or a wall.

8. The system of claim 1, further including a boundary indicator provided between at least one pair of neighboring zones.

9. The system of claim 1, further including a boundary indicator provided along at least an outer portion of a zone that is not bordered by another zone.

10. The system of claim 1, wherein the presentation medium presents one or more sample characters.

11. The system of claim 10, wherein the presentation medium presents one or more direction indicators with the one or more sample characters.

12. The system of claim 1, wherein the presentation medium presents instructions for forming a character.

13. The system of claim 1, wherein the presentation medium presents a legend indicating a thing corresponding to the color associated with each zone.

14. The system of claim 1, wherein the zones are substantially identical in size and shape.

15. The system of claim 1, wherein the zones are stacked in a vertical direction.

16. A system for facilitating the development of handwriting comprising:
a presentation medium;
a user writing area presented by the presentation medium, the user writing area including three vertically stacked zones, the three zones being substantially identical in size and shape, at least a portion of each of the zones including an associated color, the color associated with each zone being different from the color of the other zones, the colors of the zones being selected and arranged according to a spatial relationship.

17. The system of claim 16, wherein the presentation medium is a display of an electronic device.

18. The system of claim 16, further including a boundary indicator provided between at least one pair of neighboring zones.

19. The system of claim 16, further including a boundary indicator provided along at least an outer portion of a zone that is not bordered by another zone.

20. The system of claim 16, wherein the three zones include an upper zone, a middle zone and a lower zone, wherein the color associated with the upper zone is blue, wherein the color associated with the middle zone is green, and wherein the color associated with the lower zone is brown.
